(19) United States
(12) Patent Application Publication
(10) Pub. No.: US 2010/0103445 A1
(43) Pub. Date: Apr. 29, 2010

(54) SYSTEM AND METHOD FOR PROCESSING A DOCUMENT WORKFLOW

(75) Inventors: Jonathan Levine, Rochester, NY (US); Lee Moore, Penfield, NY (US); Eugene Evanitsky, Pittsford, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/258,713

(22) Filed: Oct. 27, 2008

(51) Int. Cl. G06F 15/00

(52) U.S. Cl. 358/1.15

(57) ABSTRACT

A method of processing a document workflow includes the initial step of providing a document workflow system including a grid computing system in communication with at least one I/O device. The document workflow system is configured to process at least one print job. The method also includes the step of partitioning the processing of the at least one print job between the grid computing system and the at least one I/O device. The grid computing system is configured to process at least one non-physical component of the document workflow and the at least one I/O device is configured to process at least one physical component of the document workflow.

### BACKGROUND

1. Technical Field

The present disclosure relates to grid computing environments, and, in particular, to a system and method for processing a document workflow.

2. Description of Related Art

Grid computing systems are widely available. Conventional grid computing systems enable a user to utilize distributed resources (e.g., software services, storage services, etc.) through a centralized interface to access capabilities such as printing and document related services over various networks. Typically, available grid computing systems enable computing processing and storage using a similar “utility” model as power distribution grids. This centralized configuration of the grid computing system allows businesses to reduce manufacturing costs associated with, for example, deployment, implementation, and maintenance of software and electronics. In use, the user can submit a job to the grid computing system over a network such as, for example, the Internet. If the user wishes to print the results of the submitted job, the user may submit corresponding data such as, for example, a script file with the job. This script file may include a print command for a specific printer and printer-specific information, which gets executed by software and/or electronics onboard the printer to drive the printer to print the job.

The above-described workflow model does not take advantage of the processing and storage power of grid computing systems. That is, grid computing systems in conjunction with the wide availability of high bandwidth fiber optic networks make it possible to disrupt the conventional method for providing printing and document related services. Conventional methods for providing printing services require expensive software and electronics to be installed and maintained at printing devices locally rather than taking advantage of the processing and storage power of grid computing system resources to centralize document output workflow control.

### SUMMARY

In an embodiment of the present disclosure, a method of processing a document workflow includes the initial step of providing a document workflow system including a grid computing system in communication with at least one I/O device. The document workflow system is configured to process at least one print job. The method also includes the step of partitioning the processing of the at least one print job between the grid computing system and the at least one I/O device. The grid computing system is configured to process at least one non-physical component of the document workflow and the at least one I/O device is configured to process at least one physical component of the document workflow.

In another embodiment of the present disclosure, a method of processing a document workflow includes the initial step of providing a document workflow system including a grid computing system in communication with at least one I/O device. The document workflow system is configured to process at least one print job. The method also includes the step of hosting the grid computing system on user-accessible network to facilitate the communication of the at least one print job from the user to the grid computing system. The method also includes partitioning the processing of the at least one print job between the grid computing system and the at least one I/O device. The grid computing system is configured to process at least one non-physical component of the document workflow and the at least one I/O device is configured to process at least one physical component of the document workflow.

In another embodiment of the present disclosure, a method of providing a grid-enabled document workflow processing service includes the initial step of providing a document workflow system including a grid computing system in communication with at least one I/O device. The document workflow system configured to process at least one print job. The method also includes the step of hosting the grid computing system on a user-accessible network to facilitate the communication of the at least one print job from the user to the grid computing system. The method also includes the step of partitioning the processing of the at least one print job between the grid computing system and the at least on I/O device. The grid computing system is configured to process at least one non-physical component of the document workflow and the at least one I/O device is configured to process at least one physical component of the document workflow.

### BRIEF DESCRIPTION OF THE DRAWINGS

These and other advantages will become more apparent from the following detailed description of the various embodiments of the present disclosure with reference to the drawings wherein:

FIG. 1 is a block diagram of a grid-enabled document workflow services system in accordance with the present disclosure;

FIG. 2 is a block diagram of an I/O device of the system of FIG. 1;

FIG. 3 is a block diagram of a grid computing infrastructure of the system of FIG. 1; and

FIG. 4 is a flow chart diagram illustrating a method for providing a grid-enabled document workflow service in accordance with the present disclosure.

### DETAILED DESCRIPTION

Embodiments of the presently disclosed advertisement system will now be described in detail with reference to the drawings in which like reference numerals designate identical or corresponding elements in each of the several views.

The present disclosure relates to grid computing environments, and, in particular, to a system and method for providing a centralized hosted document workflow service utilizing a grid computing system. With this purpose in mind, the present disclosure provides for a document workflow control system including a centralized hosted grid computing infrastructure or grid computing system in communication with one or more printing devices and/or scanning devices. The grid computing system combines network, storage, computing, and software elements to provide centralized processing power. Users connect to, purchase, and utilize the centralized processing power of the grid computing system to drive one or more I/O devices and, in turn, execute document related jobs, such as print jobs. As will be discussed in further detail below, certain steps of the document workflow typically executed by the printing/scanning device, are centralized and provided by the grid computing system, such that printing/scanning devices may be configured as basic I/O devices. More specifically, the work required to execute print jobs is partitioned between certain steps of the document workflow to optimize the performance of printing devices and/or scanning devices and, further, to reduce costs associated with manufacturing and designing printing devices and/or scanning devices.

The grid computing system may be hosted on, for example, a network server accessible by users via the Internet through use of a web-based user interface. In this scenario, the hosted grid computing system operates on a network separate from a network on which the one or more I/O devices operate. Alternatively or additionally, the grid computing system may be in bidirectional communication with the one or more I/O devices in a networked configuration, such that the grid computing system and the one or more I/O devices operate on the same network. In embodiments, the grid computing system may incorporate a firewall configured to permit or deny traffic to the grid computing system.

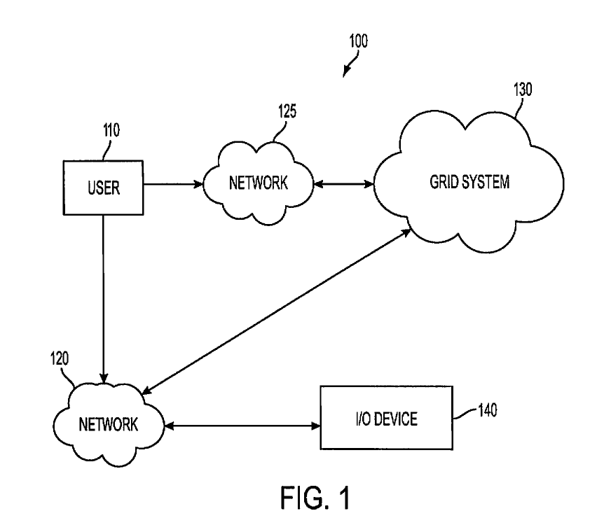

It should be understood that an I/O device (e.g., I/O device 140 of FIG. 1), as described herein, may be an output device (e.g., a device configured to output documents and/or data), an input device (e.g., a device configured to input documents and/or data), or both an input device and an output device (e.g., a device configured to input and output documents and/or data).

The so-called “non-physical” components of the document workflow (or print job workflow) are executed by the grid computing system. By way of example without limitation, “non-physical” components of the document workflow may include business operations (e.g., customer self-service, quoting, estimating, order-intake, billing), intent-to-process conversion, pre-flight, imposition, interpreting, raster image processing, image processing from scanners and/or cameras, faxing, content management, and manufacturing execution system (MES) flow control. In this scenario, printing devices and/or scanning devices may be manufactured as basic I/O devices configured to execute the so-called “physical” components of the document workflow (or print job workflow). By way of example without limitation, “physical” components of the document workflow may include marking or printing of print jobs, binding documents, trimming documents, packaging print jobs, and shipping print jobs. In this manner, costs associated with implementation of the grid computing system are reduced via resource sharing and, further, printing device and/or scanning device design may be simplified to reduce manufacturing and development costs associated with, without limitation, software and electronics implementation. Further, the grid computing system provides, without limitation, the shared computing power of multiple devices (e.g., I/O devices) on a network (e.g., LAN, WAN, Internet, etc.) to provide utility computing and/or so-called “pay-as-you-go” computing, wherein users of the grid computing system pay only for the services or resources that they use (e.g., hosted software applications, Software as a Service, etc.). Additionally, utility computing allows for the provisioning of available CPU cycles (e.g., from available I/O devices), data centers, networks, computers, storage devices, etc. Other advantages provided by the grid computing system include, without limitation, a platform for newly developed document services, reduced costs associated with deploying and maintaining software, simplified accounting of printing services (e.g., meter reading and billing), and centralized collection of business sensitive data.

As will be discussed in further detail below, the grid computing system distributes or communicates the processed print job(s) to the appropriate I/O device(s) for output or printing. Further, the grid computing system is configured with a plurality of functionalities (e.g., hosted software services) that provide the user with processing power to control the document workflow and/or drive one or more I/O device(s) to execute print jobs. For example, the grid computing system provides hosted software services that users may be charged a fee to utilize for printing and document related services. That is, the grid computing system processes and stores data corresponding to utilization of specific software services utilized by a particular user for any number of associated I/O devices. In this scenario, users may be billed only for services that they use and, further, the corresponding record of usage is centralized at the grid computing system. This enables retrieval of billing records from a centralized location rather than the relatively more time consuming and expensive method of retrieval of billing records from one or more individual I/O devices. Further, historical print job statistics (e.g., executed print jobs) may be utilized to optimize the workflow process.

In embodiments of the present disclosure, a user submits one or more jobs or print jobs to the grid computing system. Print jobs may be communicated over the network to the grid computing system via one or more I/O devices (e.g., printing devices) in bidirectional communication with the grid computing system. Additionally or alternatively, print jobs may be communicated over the network to the grid computing system via a suitable network-enabled computing device (e.g., computer, cell phone, etc.). The grid computing system processes the received print job(s) and, further, stores the processed print job(s) (or data corresponding to the processed print job(s)) for subsequent retrieval and/or processing. The grid computing system includes hosted services or functionalities corresponding to processed and/or stored print jobs including, without limitation, data content management, data extraction, summarization, language conversion, publishing, authentication, FAX, etc. The grid computing system further includes hosted services or functionalities corresponding to document and/or print job workflow including, without limitation, real-time remote technical support, real-time remote workflow deployment, job composition and pre-press functionality to facilitate previewing of job output (e.g., via a computer interface), sending of print jobs for “physical” printing, distribution, diagnostics, billing and reporting, receiving of scanned images communicated from any suitable source, centralized system debugging, and an application programming interface (API) to allow the system administrator and/or program developers to provide customized services (e.g., software applications) operating on the grid computing system.

Reference is first made to FIG. 1, which shows system architecture of a grid-enabled document workflow processing system 100 in accordance with embodiments of the present disclosure. The processing system 100 accepts jobs and/or print jobs from a user 110 describing the document. Print jobs may include, without limitation, print specifications (e.g., number of copies, print color or monochrome, paper size, paper orientation, printer location/identification, etc.), page description language (PDL) commands, raster images and bitmaps, etc.

Generally, processing system 100 includes a grid computing system 130 in communication with one or more I/O devices 140 over a network 120 (e.g., Internet, WAN, LAN, Bluetooth, etc.). In one embodiment, users 110 access the grid computing system 130 via a network 125 distinct from network 120, as illustrated in FIG. 1. Network 125 may be, for example, the Internet, wherein users 110 access the grid computing system 130 through a web-based interface (not explicitly shown). In another embodiment, users 110 access the grid computing system 130 via the same network (e.g., network 120) through which the grid computing system 130 communicates with the one or more I/O devices 140. In either scenario, access to the grid computing system 130 may be achieved through use of the I/O device 140 and/or any suitable network-enabled computing device including, without limitation, a computer, a hand-held computing device, a cell phone, a personal digital assistant (PDA), etc. As such, the grid computing system 130 is configured to communicate print jobs to the one or more I/O devices 140 and/or any suitable network-enabled computing device (e.g., computer, hand-held device, cell phone, PDA, etc.).

The processing system 100 may employ any suitable software application to provide an interface to enable the user 110 to submit a print job to the grid computing system 130. Further, the grid computing system 130 may employ components suitable to process, store, and distribute data over the network 120 to one or more I/O devices 140 (e.g., RAM, processor, network interface, etc.). The I/O device 140 depicted in FIG. 1 is illustrative only in that the processing system 100 is configured to operate as a shared or distributed resource among one or more I/O devices in a networked configuration. In embodiments, I/O device 140 may be a Xerographic printing device such as the iGen 4 machine manufactured by Xerox.

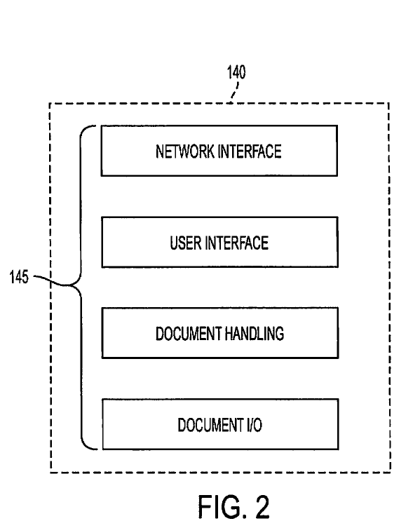

As shown in FIG. 2, an I/O device 140 of the disclosed processing system 100 includes a plurality of functionalities 145 (e.g., “physical” components of the workflow) configured to facilitate operation of I/O device 140 within processing system 100. More specifically, I/O device 140 includes a network interface configured to facilitate bidirectional communication over the network 120 between the I/O device 140 and the grid computing system 130. The network interface of the I/O device 140 facilitates communication of print jobs over the network 120 from the I/O device 140 to the grid computing system 130 and, subsequently, communication of processed print jobs from the grid computing system 130 to the I/O device 140. Further, the network interface of the I/O device 140 facilitates so called “self-identification” of that particular device. That is, I/O devices of the disclosed processing system 100 may “identify” functional capabilities (e.g., binding, stapling, hole punching, packaging, etc.) of that particular device, which are discoverable by the grid computing system 130 and made available to the user 110.

Other functionalities 145 of the I/O device include a user interface configured to provide, for example, device operation information (e.g., paper jam clearance), document handling (e.g., high performance document imaging, color reproduction, etc.), and document I/O including, without limitation, data communication from a device input (e.g., scanner, paper tray, etc.) to the grid computing system 130 and subsequently receive print job data driven by a hosted service operating on the grid computing system 130, as will be discussed in further detail below.

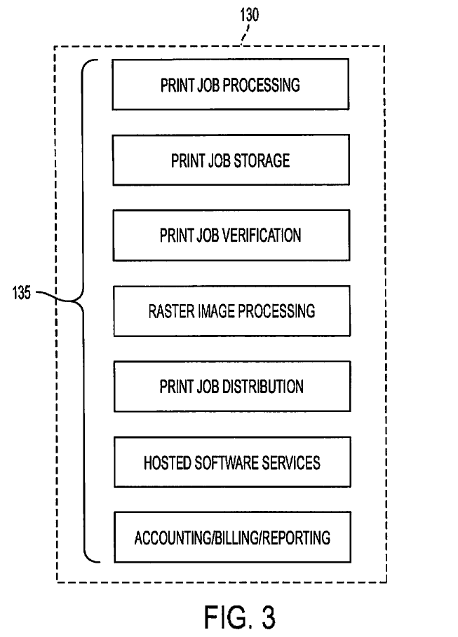

As shown in FIG. 3, grid computing system 130 includes a plurality of functionalities 135 (e.g., “non-physical” components of the workflow) configured to facilitate operation of grid computing system 130 within processing system 100. For example, grid computing system 130 provides print job processing and/or storage of print jobs communicated from the user 110 over the network 120 and/or network 125. With this purpose in mind, grid computing system 130 may employ a suitable processing device (e.g., CPU) in communication with a storage device (e.g., RAM). Additionally, grid computing system 130 receives, processes, and stores input from system administrators and program developers such as, without limitation, software updates and installs. Grid computing system 130 further provides print job verification (e.g., via virtual display of print job output to a suitable computing device interface). Grid computing system 130 further provides Raster Image Processing (RIP) of print jobs and, subsequently, drives the appropriate I/O device(s) with the RIPed print job(s). Grid computing system 130 is further configured to distribute print jobs to appropriate I/O devices 140 and/or among a plurality networked I/O devices. In this manner, the distribution of print jobs is centralized at the grid computing system 130 and the document workflow is manageable by the user 110 through use of the grid computing system 130. Grid computing system 130 also provides accounting and/or billing applications configured to track billing and reporting of print jobs and/or I/O device usage of particular users, groups, etc.

Print jobs are distributed or communicated from the grid computing system 130 over the network 120 to one or more I/O devices 140. Once distributed to the appropriate I/O device(s), the I/O device(s), as discussed hereinabove, operates to output or print the distributed print job. By way of the grid computing system functionalities 135, the grid computing system 130 provides document output workflow control of the I/O device(s).

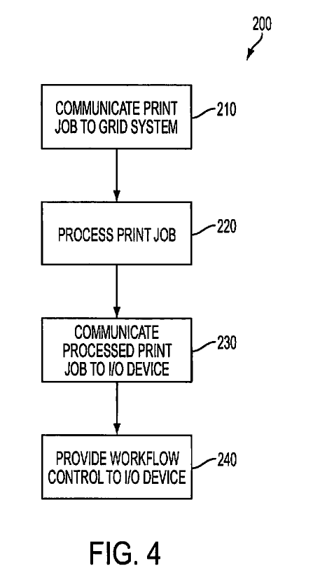

FIG. 4 shows a method 200 for providing a grid-enabled document workflow service. In step 210, one or more print jobs is communicated to the grid computing system 130. That is, the user 110 utilizes an appropriate network-enabled device (e.g., I/O device 140) to send print jobs to the grid computing system 130. As discussed hereinabove, the network-enabled device may be an I/O device 140 itself (e.g., printing device and/or scanning device) or may be a remote computing device (e.g., computer, cell phone, etc.) suitable to communicate data over network 125 and/or network 120. In step 220, the grid computing system 130 processes the print job received from the user 110. As discussed hereinabove, the print job may be stored by the grid computing system 130 for subsequent retrieval and, further, may be manipulated by the grid computing system 130 utilizing the provided functionalities 135 (e.g., hosted software services) of grid computing system 130. In step 230, the grid computing system 130 communicates the processed print job(s) to the appropriate I/O device(s) 140. Once received by the appropriate I/O device(s) 140, the distributed print job(s) are output and/or printed. In step 240, the functionalities 135 of grid computing system 130 operate to provide workflow control of the print job(s) received and output by the I/O device(s) 140. Step 240 may be executed simultaneously with step 230 or subsequently to step 230.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of processing a document workflow, the steps comprising:
providing a document workflow system including a grid computing system in communication with at least one I/O device, the document workflow system configured to process at least one print job; and
partitioning the processing of the at least one print job between the grid computing system and the at least one I/O device, wherein the grid computing system is configured to process at least one non-physical component of the document workflow and the at least one I/O device is configured to process at least one physical component of the document workflow.

2. A method according to claim 1, further comprising the step of:
hosting the grid computing system on a first user-accessible network to facilitate the communication of the at least one print job from the user to the grid computing system; and
communicating the at least one processed print job via a second network from the grid computing system to the at least one I/O device.

3. A method according to claim 1, further comprising the step of:
hosting the grid computing system on a user-accessible network to facilitate the communication of the at least one print job from the user to the grid computing system; and
communicating the at least one processed print job from the grid computing system to the at least one I/O device via the user-accessible network.

4. A method according to claim 1, wherein the at least one physical component of the document workflow includes printing the at least one processed print job.

5. A method according to claim 1, wherein the at least one physical component of the document workflow includes at least one of binding the at least one processed print job, trimming the at least one processed print job, packaging the at least one processed print job, and shipping the at least one processed print job.

6. A method according to claim 1, further comprising the step of:
hosting the grid computing system on a network server accessible by the user through a web-based interface.

7. A method according to claim 1, wherein the at least one non-physical component of the document workflow includes providing at least one hosted software service.

8. A method according to claim 1, wherein the at least one non-physical component of the document workflow includes raster image processing the at least one print job and driving the at least one I/O device with the at least one processed print job.

9. A method according to claim 1, further comprising the step of:
providing a utility computing service via the grid computing system, wherein the user is charged a fee based on usage of the at least one non-physical component of the document workflow.

10. A method according to claim 1, wherein the I/O device is at least one of a printing device and a scanning device.

11. A method according to claim 1, further comprising the step of:
identifying the at least one physical component of the document workflow to the grid computing system.

12. A method of processing a document workflow, the steps comprising:
providing a document workflow system including a grid computing system in communication with at least one I/O device, the document workflow system configured to process at least one print job;
hosting the grid computing system on a user-accessible network to facilitate the communication of the at least one print job from the user to the grid computing system; and
partitioning the processing of the at least one print job between the computing grid and the at least one I/O device, wherein the grid computing system is configured to process at least one non-physical component of the document workflow and the at least one I/O device is configured to process at least one physical component of the document workflow.

13. A method according to claim 12, further comprising the step of:
communicating the at least one processed print job from the grid computing system to the at least one I/O device via a network separate from the user-accessible network.

14. A method according to claim 12, further comprising the step of:
communicating the at least one processed print job from the grid computing system to the at least one I/O device via the user-accessible network.

15. A method of providing a grid-enabled document workflow processing service, the steps comprising:
providing a document workflow system including a grid computing system in communication with at least one I/O device, the document workflow system configured to process at least one print job;
hosting the grid computing system on a user-accessible network to facilitate the communication of the at least one print job from the user to the grid computing system; and
partitioning the processing of the at least one print job between the grid computing system and the at least on I/O device, wherein the grid computing system is configured to process at least one non-physical component of the document workflow and the at least one I/O device is configured to process at least one physical component of the document workflow.

16. A method according to claim 15, wherein the user-accessible network is hosted on a network server accessible by the user via the Internet through a web-based interface.

17. A method according to claim 15, further comprising the step of:
communicating the at least one processed print job from the grid computing system to the at least one I/O device.

18. A method according to claim 15, wherein the at least one physical component of the document workflow includes at least one of binding the at least one processed print job, trimming the at least one processed print job, packaging the at least one processed print job, and shipping the at least one processed print job.

19. A method according to claim 15, wherein the at least one physical component of the document workflow includes printing the at least one processed print job via the at least one I/O device.

20. A method according to claim 15, further comprising the step of:
providing a utility computing service configured to host at least one user-accessible software application via the grid computing system; and
charging the user a fee based on usage of the at least one user-accessible software application.
